(19) United States
(12) Patent Application Publication
(10) Pub. No.: US 2006/0263101 A1
(43) Pub. Date: Nov. 23, 2006

(54) Sheet identifying device and method

(76) Inventors: Seiji Takamatsu, Saitama (JP); Satoru Tsurumarki, Saitama (JP); Yasuyuki Kimura, Saitama (JP)

Correspondence Address: FISH & RICHARDSON P.C., P.O. BOX 1022, MINNEAPOLIS, MN, 55440-1022, US

(21) Appl. No.: 10/554,253

(22) PCT Filed: Apr. 23, 2004
(86) PCT No.: PCT/JP04/05932

§ 371 Date: Oct. 24, 2005

(30) Foreign Application Priority Data
Apr. 23, 2003 (JP) 2003-121837

(51) Int. Cl. G03G 15/00

(52) U.S. Cl. 399/4

(57) ABSTRACT

A sheet paper identification apparatus and method for stably identifying a sheet paper while preventing erroneous identification caused by dust adhered to an imaging section and caused by fluctuation in illumination brightness. An imaging section (7) images the interior of the imaging section (7) before a sheet paper is fed to capture image data on an image showing no sheet paper. When a sheet paper is fed into the imaging section (7), the imaging section (7) images the sheet paper and captures image data on an image showing a sheet paper. An image data analyzing section (8) creates a density histogram of the image showing no sheet paper from the image data on the image showing no sheet paper and detects dust adhered to the imaging section (7) on the basis of the density histogram. If the amount of particles exceeds a reference value, the image data analyzing section (8) sends a report about the abnormality of the imaging section (7) to a control section (2). The image data analyzing section (8) creates a density histogram of the image showing a sheet paper from the image data on the image showing a sheet paper, determines brightness of the image on the basis of the density histogram, and adjusts imaging operations of the imaging section (7) according to the determination.

### TECHNICAL FIELD

The present invention relates to a sheet paper identification apparatus and method and, more particularly, to a sheet paper identification apparatus and method for determining the type and authenticity of sheet papers by extracting characteristics thereof in the form of an image.

### BACKGROUND ART

Generally, identification of type and authenticity of sheet papers, such as bills, checks, and gift certificates, is performed by magnetically or optically extracting the characteristics of the sheet paper which is inserted by a user with a magnetic sensor or a light sensor.

For extraction of optical characteristics of a sheet paper by means of a light sensor, design, dimensions, orientation, and the like of the sheet paper are extracted using a transmission-type or a reflective type light sensor to acquire image patterns of the characteristics, and the acquired image patterns are compared with a standard pattern of a genuine note for each type, whereby the type and authenticity of the inserted sheet paper are identified.

Here, as disclosed in Japanese Patent Application Laid-Open No. 2002-92683 for example, discrimination between genuine and counterfeit media is performed by reading an image of a medium by means of a CCD sensor using transmitted light, extracting a pattern of a watermark region of the medium from the image thus read, and removing the effects of nonlinear blurring of the extracted pattern data.

Further, as disclosed in Japanese Patent Application Laid-Open No. 6-203244 for example, in order to reduce the effects of noise caused by dirt or the like attached to a bill, identification as to whether the bill is genuine or counterfeit is performed by reading a watermark pattern of the bill with two optical reading means that utilize transmitted light and reflected light and comparing both data sets thus read.

However, in the prior arts cited above, even when dust is attached to the interior of an imaging section, identification based on the image of the bill is performed without identifying the existence of dust. Therefore, there was the inconvenience of erroneous identification or the like caused by dust, and the sheet paper identification apparatus was used while identification was not performed correctly because an abnormal state in the imaging section caused by dust was not communicated to the outside, thereby allowing no further acceptance of the sheet paper.

Furthermore, erroneous identification or the like was caused by fluctuation in the density of an image of the sheet paper due to the fluctuation in brightness of illumination, which was caused by deterioration of the light-emitting devices used for the illumination of the interior of the imaging section in which the sheet paper is exposed to light or by changes in ambient temperatures, thereby allowing no further acceptance of the sheet paper until a person such as an administrator conducts maintenance of the imaging section.

### DISCLOSURE OF THE INVENTION

Taking the above into consideration, the object of the present invention is to provide a sheet paper identification apparatus and method that enable stable identification of sheet paper by preventing erroneous identification caused by dust attached to the interior of the imaging section and preventing erroneous identification caused by fluctuation in illumination brightness.

In order to achieve the above object, an invention of claim 1 is a sheet paper identification apparatus that performs identification of a sheet paper on the basis of an image of the sheet paper, and the sheet paper identification apparatus comprises an image acquisition means for acquiring an image in a specified area of the sheet paper, image contrast analysis means for analyzing contrast of the image acquired by the image acquisition means, and imaging condition adjusting means for adjusting a condition for imaging the image on the basis of a result of the analysis on the contrast performed by the image contrast analysis means.

Further, the invention of claim 2 is the sheet paper identification apparatus according to claim 1, wherein the image contrast analysis means comprises a means for creating a density histogram from the image acquired by the image acquisition means, and analyzes the contrast of the image on the basis of the density histogram created by the histogram creation means.

Furthermore, the invention of claim 3 is the sheet paper identification apparatus according to claim 2, further comprising a means to judge the acquisition of an image which is in a state where no sheet paper exists in an imaging section that images the sheet paper and judging an unwanted image based on a density histogram of the acquired image, and a means for prohibiting identification of the sheet paper when the judging means judges that an unwanted image exists.

The invention of claim 4 is the sheet paper identification apparatus according to claim 3, wherein the judging means includes a means for counting the number of pixels in a density value within a preset range on the basis of the density histogram and judges that an unwanted image exists when the number of pixels counted by the counting means exceeds a predetermined reference value.

Moreover, the invention of claim 5 is the sheet paper identification apparatus according to claim 2, wherein the image contrast analysis means includes a means for counting the number of pixels of a density value within a preset range based on the density histogram, analyzes the contrast of the image by checking whether or not the number of pixels counted by the counting means is within a preset reference range, and the imaging condition adjusting means adjusts an output of an imaging means for imaging the sheet paper so that the number of pixels falls within the reference range.

Further, the invention of claim 6 is the sheet paper identification apparatus according to claim 2, wherein the image contrast analysis means includes a means for counting the number of pixels of a density value within a preset range on the basis of the density histogram, analyzes the contrast of the image by checking whether or not the number of pixels counted by the counting means is within a preset reference range, and the imaging condition adjusting means adjusts illumination time of illumination means for illuminating the sheet paper so that the number of pixels falls within the reference range.

The invention of claim 7 is the sheet paper identification apparatus according to claim 1, wherein the image acquisition means acquires a transparent image in a watermark region in which a watermark pattern of the sheet paper exists, and the imaging condition adjusting means adjusts a condition for imaging the transparent image.

Here, the transparent image in the watermark region is an image acquired based on light transmitted through the watermark region of the sheet paper.

The invention of claim 8 is a sheet paper identification method for identifing a sheet paper on the basis of an image of the sheet paper, wherein an image in a specified area of the sheet paper is acquired by an image acquisition means, the contrast of the image acquired by the image acquisition means is analyzed by an image contrast analysis means, and a condition for imaging the image is adjusted by an imaging condition adjusting means on the basis of a result of the analysis of the contrast performed by the image contrast analysis means.

Further, the invention of claim 9 is the sheet paper identification method according to claim 8, wherein the image contrast analysis means uses the histogram creation means to create a density histogram from the image acquired by the image acquisition means and analyzes the contrast of the image on the basis of the density histogram created by the histogram creation means.

Furthermore, the invention of claim 10 is the sheet paper identification method according to claim 9, wherein a judging means acquires an image which is in a state where no sheet paper exists in the imaging section that images the sheet paper, judges an unwanted image based on the density histogram of the acquired image, and the identification prohibition means prohibits identification of the sheet paper when the judging means judges that an unwanted image exists.

The invention of claim 11 is the sheet paper identification method according to claim 10, wherein the judging means counts the number of pixels of a density value within a preset range by the counting means on the basis of the density histogram and judges that an unwanted image exists when the number of pixels counted by the counting means exceeds a preset reference value.

The invention of claim 12 is the sheet paper identification method according to claim 9, wherein the image contrast analysis means counts the number of pixels of a density value within a preset range by the counting means on the basis of the density histogram, analyzes the contrast of the image by checking whether or not the number of pixels counted by the counting means is within a preset reference range, and the imaging condition adjusting means adjusts output of the imaging means for imaging the sheet paper so that the number of pixels falls within the reference range.

The invention of claim 13 is the sheet paper identification method according to claim 9, wherein the image contrast analysis means counts the number of pixels of a density value within a preset range by means of the counting means on the basis of the density histogram, analyzes the contrast of the image by checking whether or not the number of pixels counted by the counting means is within a preset reference range, and the imaging condition adjusting means adjusts illumination time of the illumination means for illuminating the sheet paper so that the number of pixels falls within the reference range.

The invention of claim 14 is the sheet paper identification method according to claim 8, wherein the image acquisition means acquires a transparent image in a watermark region in which a watermark pattern of the sheet paper exists and the imaging condition adjusting means adjusts a condition for imaging the transparent image.

### BRIEF DESCRIPTION OF THE DRAWINGS

FIG. 1 is a block diagram showing an example of the functional constitution of a sheet paper identification apparatus 1 according to the present invention;

FIG. 2 is a block diagram showing an example of the functional constitution of an imaging section 7, an image data analysis section 8, and an identification section 9;

FIG. 3 is a flowchart showing the processing procedure performed by the sheet paper identification apparatus 1 when type and authenticity of inserted sheet paper are identified;

FIGS. 4(a) and 4(b) are figures explaining the processing in which a dust analysis section 14 analyzes dust attached to the interior of the imaging section 7 by means of a density histogram of an image showing no sheet paper;

FIGS. 5(a) and 5(b) are figures explaining the processing in which the dust analysis section 14 analyzes dust attached to the interior of the imaging section 7 by means of a density histogram of an image showing no sheet paper; and

FIGS. 6(a) to 6(c) are figures explaining the processing in which an image contrast analysis section 15 analyzes brightness of an image showing sheet paper by means of a density histogram of the image.

### BEST MODE FOR CARRYING OUT THE INVENTION

Hereinafter, embodiments of the sheet paper identification apparatus and method according to the present invention will be described in detail with reference to the attached drawings.

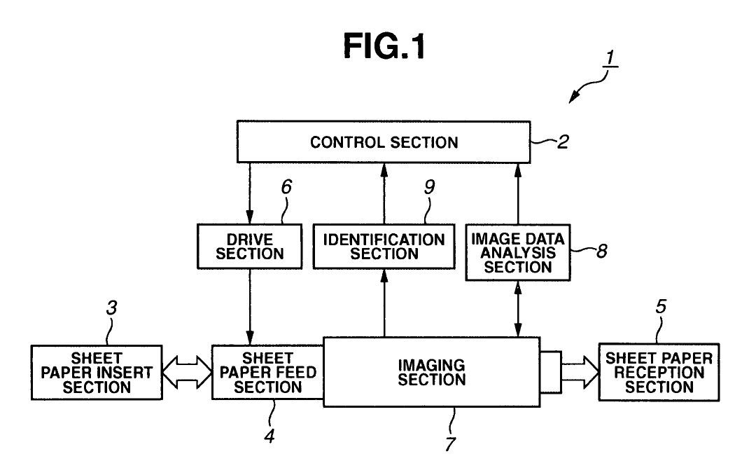

FIG. 1 is a block diagram showing an example of the functional constitution of a sheet paper identification apparatus 1 according to the present invention.

As shown in FIG. 1, the sheet paper identification apparatus 1 includes a control section 2, which controls the entire sheet paper identification apparatus 1; a sheet paper insert section 3, which is a sheet paper inlet; a sheet paper feed section 4 for conveying a sheet paper; a sheet paper receipt section 5 for receiving the sheet paper; a drive section 6 for driving the sheet paper feed section 4 by means of control by the control section 2; an imaging section 7, which acquires image data showing no sheet paper by imaging sheet paper inserted into the sheet paper insert section 3 before arrival of the sheet paper and acquires image data showing a sheet paper by imaging the sheet paper after arrival of the sheet paper; an image data analysis section 8 for analyzing the image data showing no sheet paper and the image data showing a sheet paper that have been acquired by the imaging section 7 to detect dust attached to the interior of the imaging section 7 and judge brightness of the image; and an identification section 9 for identifying type and authenticity of the sheet paper on the basis of the image data showing a sheet paper acquired by the imaging section 7.

Next, functional operations, which are performed by the sheet paper identification apparatus 1 when type and authenticity of the inserted sheet paper are identified, will be described.

When sheet paper is inserted from the sheet paper insert section 3, the control section 2 feeds the sheet paper by means of the sheet paper feed section 4 by controlling the drive section 6. Here, the imaging section 7 images the interior of the imaging section 7 before the sheet paper is fed to the imaging section 7 to acquire image data showing no sheet paper. Subsequently, when the sheet paper is fed to the imaging section 7, the imaging section 7 images the sheet paper to acquire image data showing a sheet paper, sends the image data showing no sheet paper and the image data showing a sheet paper thus acquired to the image data analysis section 8, and sends the image data showing a sheet paper to the identification section 9. When the image data analysis section 8 receives the image data showing no sheet paper and the image data showing a sheet paper, the image data analysis section 8 creates a density histogram of an image showing no sheet paper from the image data showing no sheet paper, and detects dust attached to the interior of the imaging section 7 on the basis of the created density histogram of the image showing no sheet paper. When the detected dust level does not exceed a preset reference value, the identification section 9 identifies type and authenticity of the sheet paper on the basis of the image data showing a sheet paper. When the sheet paper is identified as a genuine note, the control section 2 drives the sheet paper feed section 4 by controlling the drive section 6 to feed the sheet paper to the sheet paper receipts section 5, which then accepts the sheet paper. When the sheet paper is identified as a counterfeit note, the control section 2 drives the sheet paper feed section 4 by controlling the drive section 6 to feed the sheet paper to the sheet paper insert section 3 and returns the sheet paper. Furthermore, when the dust detected by the image data analysis section 8 exceeds the preset reference value, the notification of the abnormal state of the imaging section 7 is sent to a control section 2, and upon receipt of the notification of the abnormal state, the control section 2 notifies the abnormal state of the imaging section 7 to the control section of the main body (automatic selling machine, change machine, or the like, for example), which houses the sheet paper identification apparatus 1.

The image data analysis section 8 creates a density histogram of an image showing a sheet paper from the image data showing a sheet paper, judges brightness of the image based on the created density histogram of the image showing a sheet paper, and performs imaging adjustment of the imaging section 7 based on this judgment.

It should be noted that, when the dust detected by the image data analysis section 8 exceeds the reference value, a constitution in which the identification section 9 identifies the sheet paper may be applied or a constitution in which the identification section 9 returns the sheet paper without identifying the sheet paper may be applied.

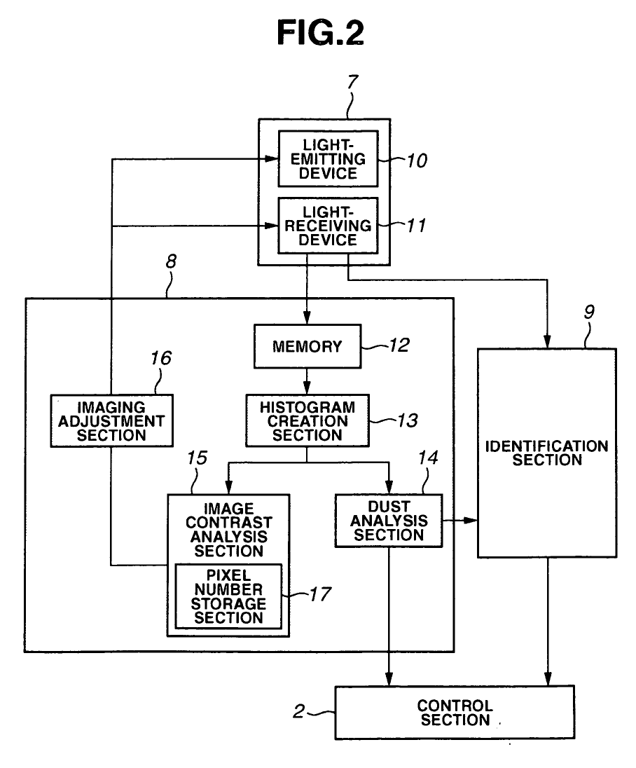

FIG. 2 is a block diagram showing an example of the functional constitution of the imaging section 7, image data analysis section 8, and identification section 9.

As shown in FIG. 2, the imaging section 7 is constituted by a light-emitting device 10 and a light-receiving device 11. The image data analysis section 8 is constituted by memory 12, a histogram creation section 13, a dust analysis 14, an image contrast analysis section 15, and an imaging adjustment section 16.

Here, in the case of a constitution where the light-emitting device 10 irradiates light onto the sheet paper and the light-receiving device 11 receives transmitted light that has been transmitted through the sheet paper, the light-emitting device 10 and light-receiving device 11 are arranged in predetermined positions, which enable the light from the devices to pass through an imaging area of the sheet paper that constitutes an identification target so that the sheet paper feed section 4 is interposed between the light-emitting device 10 and light-receiving device 11. When acquiring image data showing a sheet paper, the light-emitting device 10 irradiates light onto the imaging area of the sheet paper, which is fed by the sheet paper feed section 4, and the light-receiving device 11 receives transmitted light that has been transmitted through the imaging area of the sheet paper. An electrical signal is output in accordance with the amount of the transmitted light that has been received. Moreover, when acquiring image data showing no sheet paper, the light-receiving device 11 receives the light irradiated by the light-emitting device 10, and an electrical signal is output in accordance with the amount of the received light.

Further, in the case of a constitution where the light-emitting device 10 irradiates light onto the sheet paper and the light-receiving device 11 receives reflected light reflected by the sheet paper, the light-emitting device 10 is disposed in a predetermined position passing through the imaging area of the sheet paper that constitutes the identification target, and the light-receiving device 11 is disposed in a position that allows the reflected light reflected by the sheet paper to be received. Further, in order to acquire the image data showing no sheet paper, a reflective plate or the like, which reflects the light of the light-emitting device 10, is disposed and, for acquiring the image data showing a sheet paper, the light-emitting device 10 irradiates light onto the imaging area of the sheet paper, which is fed by the sheet paper feed section 4, and the light-receiving device 11 receives reflected light reflected by the imaging area of the sheet paper. An electrical signal is output in accordance with the amount of the reflected light that has been received. For acquiring image data showing no sheet paper, the light-emitting device 10 irradiates light, the light-receiving device 11 receives reflected light reflected by the reflective plate or the like, and an electrical signal is output in accordance with the amount of the transmitted light that has been received.

It should be noted that either of infrared, ultraviolet, or visible light can be applied to the imaging section 7.

Further, the memory 12 temporarily stores and holds the signal levels of electrical signals that are output at a prescribed time interval by the imaging section 7 as image data by allocating serial addresses that are stored in order in a predetermined storage area.

Further, the histogram creation section 13 reads image data showing no sheet paper and image data showing a sheet paper that are stored and held by the memory 12, creates a density histogram of an image showing no sheet paper from the image data showing no sheet paper, and also creates a density histogram of an image showing a sheet paper from the image data showing a sheet paper.

The dust analysis section 14 counts the number of pixels in a preset dust analysis range for the density histogram of the image showing no sheet paper that has been created by the histogram creation section 13. When the counted number of pixels exceeds a preset reference value, a notification of the abnormal state of the imaging section 7 is sent to the control section 2. It should be noted that, when the counted number of pixels exceeds the reference value, a constitution may be applied in which a notification for disallowing the identification section 9 to identify the sheet paper is sent. When the counted number of pixels does not exceed the reference value, a constitution may be applied in which a notification for allowing the identification section 9 to identify the sheet paper is sent.

Further, the image contrast analysis section 15 includes a pixel number storage section 17, whereby counting the number of pixels in a preset image contrast analysis range for the density histogram of the image showing a sheet paper, which has been created by the histogram creation section 13, causing the pixel number storage section 17 to store and hold the counted number of pixels, and calculating an average value of the number of pixels that had been counted several times in the past and stored and held in the pixel number storage section 17. When the calculated average value is below a preset reference range, the image contrast analysis section 15 sends a notification that the average value is below the reference range to the imaging adjustment section 16. When the average value exceeds the reference range, the image contrast analysis section 15 sends a notification that the average value exceeds the reference range to the imaging adjustment section 16. When the average value is within the reference range, analysis of the density histogram is terminated without sending any notification.

Moreover, when the imaging adjustment section 16 receives the notification that the average value is below the reference range, the imaging adjustment section 16 performs an adjustment to increase the output amplifier gain of the light-receiving device 11, an adjustment to increase light emitting time of the light-emitting device 10, an adjustment to increase the light amount of the light-emitting device 10, or other adjustments. On the other hand, once receiving the notification that the average value exceeds the reference range, the imaging adjustment section 16 performs an adjustment to reduce the output amplifier gain of the light-receiving device 11, an adjustment to reduce the light emitting time of the light-emitting device 10, or an adjustment to reduce the light amount of the light-emitting device 10.

Next, the functional operations that are performed by the imaging section 7, the image data analysis section 8, and the identification section 9 when the type and authenticity of the inserted sheet paper are identified will be described.

The sheet paper inserted from the sheet paper insert section 3 is fed by the sheet paper feed section 4, the light-emitting device 10 irradiates light onto the sheet paper before the sheet paper reaches the imaging section 7, and the light-receiving device 11 receives the light or reflected light reflected by the reflective plate or the like. An electrical signal is output to the memory 12 in accordance with the amount of the received light. Upon having inputs of the electrical signal, the memory 12 temporarily stores and holds the signal level of the input electrical signal as image data showing no sheet paper. The histogram creation section 13 reads the image data showing no paper sheet that is stored and held by the memory 12, and creates a density histogram of an image showing no sheet paper from the read image data showing no sheet paper. The dust analysis section 14 counts the number of pixels in a preset dust analysis range for the density histogram of the image showing no sheet paper that has been created by the histogram creation section 13. When the counted number of pixels exceeds a preset reference value, a notification of the abnormal state of the imaging section 7 is sent to the control section 2.

Then, when the counted number of pixels does not exceed the reference value, once the sheet paper reaches the imaging section 7, the light-emitting device 10 irradiates light onto the imaging area of the sheet paper, and the light-receiving device 11 receives light that has been transmitted through or reflected on the imaging area of the sheet paper. An electrical signal is output to the memory 12 in accordance with the amount of the received light. When the memory 12 inputs the electrical signal, the memory 12 temporarily stores and holds the signal level of the input electrical signal as image data showing a sheet paper. The histogram creation section 13 reads the image data showing a sheet paper that is stored and held by the memory 12, and creates a density histogram of an image showing a sheet paper from the read image data showing a sheet paper. The image contrast analysis section 15 counts the number of pixels in the preset image contrast analysis range for the density histogram of the image showing a sheet paper that has been created by the histogram creation section 13, causes the pixel number storage section 17 to store and hold the counted number of pixels, and calculates an average value of the number of pixels that had been counted several times in the past and stored and held in the pixel number storage section 17. When the calculated average value is below the reference range, the image contrast analysis section 15 sends a notification that the average value is below the reference range to the imaging adjustment section 16. When the average value exceeds the reference range, the image contrast analysis section 15 sends a notification that the average value exceeds the reference range the imaging adjustment section 16. When the imaging adjustment section 16 receives the notification that the average value is below the reference range, the imaging adjustment section 16 performs an adjustment to increase the output amplifier gain of the light-receiving device 11, an adjustment to increase light emitting time of the light-emitting device 10, an adjustment to increase the light amount of the light-emitting device 10, or other adjustments. On the other hand, upon receiving the notification that the average value exceeds the reference range, the imaging adjustment section 16 performs an adjustment to reduce the output amplifier gain of the light-receiving device 11, an adjustment to reduce the light emitting time of the light-emitting device 10, or an adjustment to reduce the light amount of the light-emitting device 10.

The identification section 9 then judges the type and authenticity of the sheet paper on the basis of the image data showing a sheet paper and sends the judgment result to the control section 2.

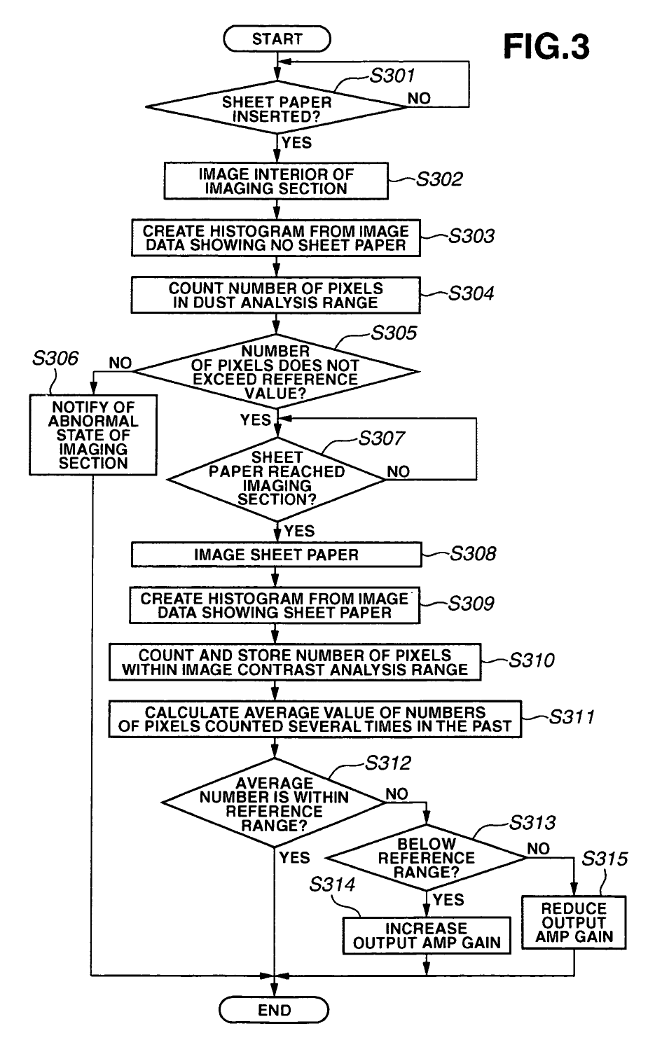

Next, the processing procedure, which is performed by the sheet paper identification apparatus I when the type and authenticity of the inserted sheet paper are identified, will be described with reference to the flowchart shown in FIG. 3.

When a sheet paper is inserted from the sheet paper insert section (YES in Step S301), the sheet paper identification apparatus images the interior of the imaging section by means of the light-emitting device and light-receiving device (Step S302); the image data showing no sheet paper is acquired; a density histogram of an image showing no sheet paper is created from the acquired image data showing no sheet paper (Step S303); the number of pixels in the dust analysis range is counted (Step S304); then when the number of pixels exceeds a preset reference range (NO in Step S305), the sheet paper identification apparatus notifies the abnormal state of the imaging section (Step S306); and terminates the processing procedures.

Further, in Step S305, when the number of pixels does not exceed the preset reference value (YES in Step S305), once the sheet paper reaches the imaging section (YES in Step S307) the sheet paper identification apparatus images the sheet paper by means of the light-emitting device and light-receiving device (Step S308), acquires image data showing a sheet paper, creates a density histogram of an image showing a sheet paper from the acquired image data showing a sheet paper (Step S309), counts and stores the number of pixels in the image contrast analysis range (Step S310), calculates an average value of the number of pixels that had been counted several times in the past (Step S311), and judges whether the average value falls below or exceeds the reference range (Step S313) when the average value exceeds the preset reference range (NO in Step S312).

Here, when the average value falls below the reference range (YES in Step S313), the sheet paper identification apparatus increases the output amplifier gain of the light-receiving device (Step S314), and then terminates the processing procedures.

Moreover, when the average value exceeds the reference range (NO in Step S313), the sheet paper identification apparatus reduces the output amplifier gain of the light-receiving device (Step S315), and then terminates the processing procedures.

Furthermore, in Step S312, when the average value is within the preset reference range (YES in Step S312), the sheet paper identification apparatus terminates the processing procedures.

It should be noted that, in Step S314, the sheet paper identification apparatus can be applied even in a processing procedure in which the light emitting time of the light-emitting device is increased, or a processing procedure in which the light amount of the light-emitting device is increased. In Step S315, the sheet paper identification apparatus can be applied even in a processing procedure in which the light emitting time of the light-emitting device is reduced, or a processing procedure in which the light amount of the light-emitting device is reduced.

Further, in Step S306, the sheet paper identification apparatus can be applied even in a processing procedure in which the abnormal state of the imaging section is notified, and identification of the sheet paper is not performed.

Next, regarding the method for identifying a sheet paper according to the present invention, which is carried out by the image data analysis section 8 and the identification section 9, there is provided a detailed explanation for a constitution as an example, wherein light is radiated from the light-emitting device 10 to the watermark region, which is the imaging area of the sheet paper, and the light-receiving device 11 receives the light transmitted by the watermark region thus acquiring image data of a watermark region.

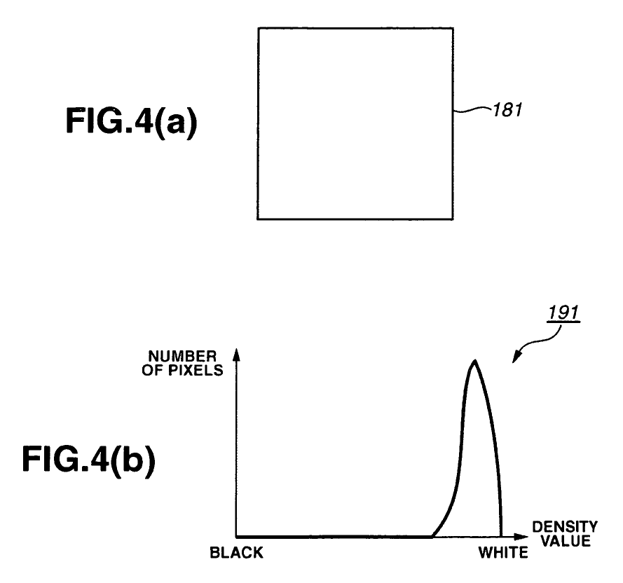

FIGS. 4(a) and 4(b) are figures explaining processing in which a dust analysis section 14 analyzes dust attached to the interior of the imaging section 7 by means of a density histogram of an image showing no sheet paper.

FIG. 4(a) is an example of image data showing no sheet paper 181 that is acquired by imaging in a state where there is no dust attached to the interior of the imaging section 7. As shown in FIG. 4(a), in a state where there is no dust attached to the interior of the imaging section 7, and since there is nothing to obscure the light emitted from the light-emitting device 10, an image is not imaged in the image data showing no sheet paper 181, and as shown in FIG. 4(b), a density histogram 191 of an image showing no sheet paper, the image of which consists mostly of pixels of a density value characterizing the image as a “white” image based on the image data showing no sheet paper 181, is created.

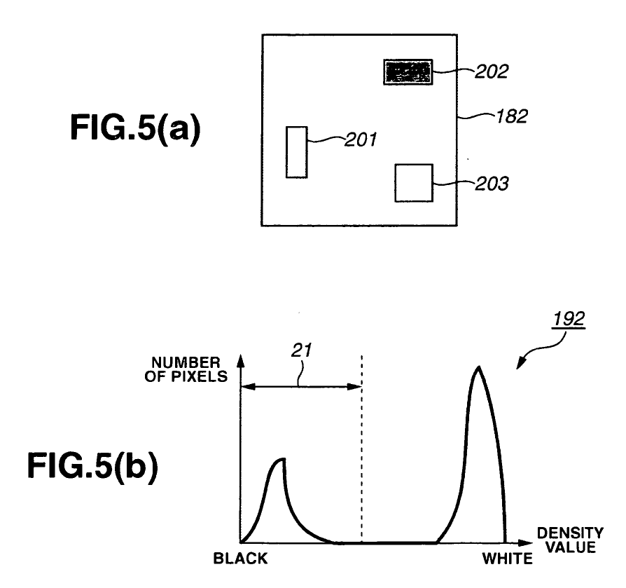

FIG. 5(a) and 5(b) are figures explaining processing in which the dust analysis section 14 analyzes dust attached to the interior of the imaging section 7 by means of a density histogram of an image showing no sheet paper.

FIG. 5(a) is an example of image data showing no sheet paper 182, which is acquired by imaging an image in a state where a plurality of dust particles are attached to the interior of the imaging section 7. As shown in FIG. 5(a), since the dust attached to the interior of the imaging section 7 obscures light emitted from the light-emitting device 10, images of dust A201, dust B202, and dust C203, for example, are imaged in the image data showing no sheet paper 182. As shown in FIG. 5(b), a density histogram 192 of an image showing no sheet paper in which pixels of a density value characterizing the image as a “black” image exist is created, although the image consists mostly of pixels of a density value characterizing the image as a “white” image based on the image data showing no sheet paper 182. More specifically, in the density histogram 192 of the image showing no sheet paper, it is possible to judge whether or not dust is attached to the interior of the imaging section 7 by counting the number of pixels in a dust analysis range 21 shown in FIG. 5(b).

The dust analysis section 14 counts the number of pixels in the dust analysis range 21 of the density histogram 192 of the image showing no sheet paper and when the counted number of pixels exceeds the preset reference value, the dust analysis section 14 analyzes that dust is attached to the interior of the imaging section 7.

Therefore, when dust exceeding the reference value is detected by analyzing the dust attached to the interior of the imaging section 7, erroneous identification caused by dust attached to the interior of the imaging section 7 can be prevented by notifing the abnormal state of the interior of the imaging section 7.

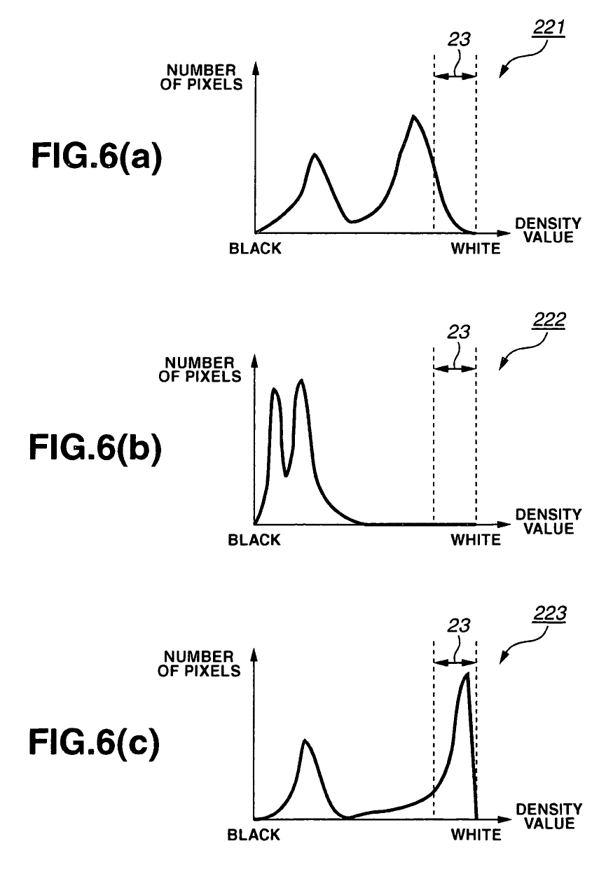

FIGS. 6(a) to 6(c) are figures explaining processing in which the image contrast analysis section 15 analyzes brightness of the image by means of a density histogram of the image showing a sheet paper.

FIG. 6(a) is an example of a density histogram 221 of an image showing a sheet paper with ideal brightness, FIG. 6(b) is an example of a density histogram 222 of an image showing a sheet paper with insufficient brightness, and FIG. 6(c) is an example of a density histogram 223 of an image showing a sheet paper with saturated brightness.

It can be analyzed according to the density histogram 222 shown in FIG. 6(b) that, if the brightness is insufficient, a large number of blackened pixels are present. Also, it can be analyzed according to the density histogram 223 shown in FIG. 6(c) that, if the brightness is saturated, a large number of pixels with too much brightness are present. More specifically, for the density histogram of the image showing a sheet paper, insufficiency or saturation of brightness of the image can be judged by counting the number of pixels in the image contrast analysis range 23 shown in FIG. 6(a) to 6(c).

Furthermore, in order to create the ideal density histogram 221 shown in FIG. 6(a), the image contrast analysis section 15 counts the number of pixels in the image contrast analysis range 23 of the density histogram of the image showing a sheet paper, judges that the brightness is insufficient if the number of pixels is below a given reference range, and makes various adjustments such as increasing the output amplifier gain of the light-receiving device 11, increasing the emitting time of the light-emitting device 10 and increasing the amount of light from the light-emitting device 10. Moreover, if the number of pixels exceed the given reference range, the image contrast analysis section 15 judges that the brightness is saturated and makes various adjustments, such as reducing the output amplifier gain of the light-receiving device 11, reducing the emitting time of the light-emitting device 10, and reducing the light amount of the light-emitting device 10 so that the ideal density histogram 221 shown in FIG. 6(a) can be created.

Therefore, when analyzing the contrast, insufficiency or saturation of brightness of the image, erroneous identification caused by fluctuation in brightness of the light can be prevented by performing imaging adjustment of the imaging section.

It should be noted that, although a constitution in which dust attached to the interior of the imaging section is detected by acquiring image data showing no sheet paper each time the sheet paper is inserted was described in the above embodiment, the use of another constitution in which detection of dust attached to the imaging section 7 is performed at regular intervals can also be applied.

Further, where the actual sheet-paper identification processing is concerned, the final conclusions on identification may be drawn in combination with other identification factors, without identifying the type and authenticity of the sheet paper by means of the sheet paper identification method according to the present invention alone.

### INDUSTRIAL APPLICABILITY

With the present invention, erroneous identification caused by dust attached to the interior of the imaging section can be prevented by analyzing the density histogram created based on the image data showing no sheet paper; also, erroneous identification caused by fluctuation in brightness of the illumination can be prevented by analyzing the density histogram created based on the image data with a sheet paper, thus enabling stable identification of sheet paper.

1. A sheet paper identification apparatus that performs identification of a sheet paper on the basis of an image of said sheet paper, the sheet paper identification apparatus comprising:
an image acquisition means for acquiring an image in a specified area of the sheet paper;
an image contrast analysis means for analyzing contrast of the image acquired by the image acquisition means; and
an imaging condition adjusting means for adjusting a condition for imaging said image on the basis of a result of the contrast analysis performed by the image contrast analysis means.

2. The sheet paper identification apparatus according to claim 1, wherein the image contrast analysis means comprises a means for creating a density histogram from the image acquired by said image acquisition means and analyzes the contrast of the image on the basis of the density histogram created by the histogram creation means.

3. The sheet paper identification apparatus according to claim 2, further comprising a means for judging the acquisition of an image that is in a state where no sheet paper exists in an imaging section, which images the sheet paper, and judging an unwanted image based on a density histogram of the acquired image, and a means for prohibiting identification of the sheet paper when the judging means determines that the unwanted image exists.

4. The sheet paper identification apparatus according to claim 3, wherein the judging means comprises a means for counting the number of pixels in a density value within a preset range on the basis of the density histogram and judges that the unwanted image exists when the number of pixels counted by the counting means exceeds a predetermined reference value.

5. The sheet paper identification apparatus according to claim 2, wherein the image contrast analysis means comprises a means for counting the number of pixels of a density value within a preset range based on said density histogram, analyzes the contrast of the image by checking whether or not the number of pixels counted by the counting means is within a preset reference range, and the imaging condition adjusting means adjusts an output of imaging means for imaging the sheet paper so that the number of pixels falls within the reference range.

6. The sheet paper identification apparatus according to claim 2, wherein the image contrast analysis means comprises a means for counting the number of pixels of a density value within a preset range on the basis of the density histogram, analyzes the contrast of the image by checking whether or not the number of pixels counted by the counting means is within a preset reference range, and the imaging condition adjusting means adjusts illumination time of illumination means for illuminating the sheet paper so that the number of pixels falls within the reference range.

7. The sheet paper identification apparatus according to claim 1, wherein the image acquisition means acquires a transparent image in a watermark region in which a watermark pattern of the sheet paper exists, and the imaging condition adjusting means adjusts a condition for imaging the transparent image.

8. A sheet paper identification method for identifying a sheet paper on the basis of an image of the sheet paper, comprising:
acquiring, by image acquisition means, an image in a specified area of the sheet paper;
analyzing, by image contrast analysis means, the contrast of the image acquired by the image acquisition means; and
adjusting, by imaging condition adjusting means, an imaging condition for the image on the basis of a result of the contrast analysis performed by the image contrast analysis means.

9. The sheet paper identification method according to claim 8, comprising:
creating, by histogram creation means, a density histogram from the image acquired by the image acquisition means; and
analyzing, by the image contrast analysis means, the contrast of the image on the basis of the density histogram created by the histogram creation means.

10. The sheet paper identification method according to claim 9, comprising:
acquiring an image, which is in a state where no sheet paper exists in a imaging section that images the sheet paper, and judging by judging means an unwanted image based on the density histogram of the acquired image; and
prohibiting, by identification prohibition means, identification of the sheet paper when the judging means judges that the unwanted image exists.

11. The sheet paper identification method according to claim 10, comprising:
counting, by counting means, the number of pixels of a density value within a preset range on the basis of the density histogram; and
judging, by the judging means, that the unwanted image exists when the number of pixels counted by the counting means exceeds a preset reference value.

12. The sheet paper identification method according to claim 9, comprising:
counting, by counting means, the number of pixels of a density value within a preset range on the basis of the density histogram;
analyzing, by the image contrast analysis means, the contrast of the image by checking whether or not the number of pixels counted by the counting means is within a preset reference range; and
adjusting, by imaging condition adjusting means, an output of imaging means for imaging the sheet paper so that the number of pixels falls within the reference range.

13. The sheet paper identification method according to claim 9, comprising:
counting, by the counting means, the number of pixels of a density value within a preset range on the basis of the density histogram;
analyzing, by the image contrast analysis means, the contrast of the image by checking whether or not the number of pixels counted by the counting means is within a preset reference range; and
adjusting, by the imaging condition adjusting means, illumination time of illumination means for illuminating the sheet paper so that the number of pixels falls within the reference range.

14. The sheet paper identification method according to claim 8, wherein the image acquisition means acquires a transparent image in a watermark region in which a watermark pattern of the sheet paper exists, and the imaging condition adjusting means adjusts a condition for imaging the transparent image.
